(19) United States
(12) Patent Application Publication
(10) Pub. No.: US 2018/0218187 A1
(43) Pub. Date: Aug. 2, 2018

(54) SYSTEMS AND METHODS FOR LINKING UNIQUE IDENTIFIERS EMBEDDED IN MACHINE VERIFIABLE MARKS

(71) Applicant: CertiRx Corporation, Research Triangle Park, NC (US)

(72) Inventors: Darrell Jerome Freeman, Research Triangle Park, NC (US); Thomas J. Mercolino, Chapel Hill, NC (US); Hersh Ashok Tapadia, Raleigh, NC (US)

(21) Appl. No.: 15/935,708

(22) Filed: Mar. 26, 2018

Related U.S. Application Data
(63) Continuation of application No. PCT/US16/53741, filed on Sep. 26, 2016.
(60) Provisional application No. 62/233,283, filed on Sep. 25, 2015.

(51) Int. Cl. G06K 7/10; G06F 21/45; G06K 7/14

(52) U.S. Cl. CPC G06K 7/10722; G06K 7/1417; G06F 21/45

(57) ABSTRACT

A method is provided. The method includes generating a label containing at least a first and a second unique identifier, associating, linked, or otherwise relating the first and second identifiers with each other. A related system and imaging device are also provided.

### CROSS REFERENCE TO RELATED APPLICATION

This application is a continuation of PCT Patent Application No. PCT/US2016/053741, filed Sep. 26, 2016, entitled “SYSTEMS AND METHODS FOR LINKING UNIQUE IDENTIFIERS EMBEDDED IN MACHINE VERIFIABLE MARKS”, which claims the benefit of U.S. Provisional Application No. 62/233,283, filed Sep. 25, 2015, entitled “SYSTEMS AND METHODS FOR LINKING UNIQUE IDENTIFIERS EMBEDDED IN MACHINE VERIFIABLE MARKS”. This application extends upon the disclosure provided in U.S. Provisional Application Ser. No. 61/479,380, filed Apr. 26, 2011, entitled “Product Authentication and Item Identification,” and U.S. Provisional Application Ser. No. 62/771,155, filed Nov. 7, 2014, entitled “Systems and Methods for Authenticating or Identifying Personnel and Personnel Related Material”. The entire disclosures of each of these matters are hereby incorporated by reference in its entirety.

### TECHNICAL FIELD

The present invention relates to systems and methods for linking and/or associating unique identifiers embedded in machine verifiable marks printed on a label, security thread, or tamper evident seal.

### BACKGROUND

Valuable articles are counterfeited or fraudulently represented. Life-saving products are always high value, and regrettably, disproportionately targeted by the bad actors that commit these crimes.

Product authentication is the means whereby a legitimate product may be distinguished from a counterfeited fake designed to resemble the genuine article. Product authentication also plays a critical role in distinguishing diverted or “gray market” products, which are by definition legitimately manufactured products distributed into markets other than originally intended in violation of a contract, law or regulation. Closely linked to product authentication are “track and trace” of product movement in the supply chain from manufacturer to intermediary suppliers and retailers to end customers.

Authentication methods are also widely used as means for providing secure access to sensitive areas or information, for example, using passwords, biometrics, or public-private key methods.

Further, product identification at the item level is desirable in cases where an individual instance of like products must be distinguished from all other instances of that product. A person's signature affixed to a document, whether done so manually or through digital processes, falls into this latter category.

Also useful is the authentication and identification of text in documents subject to changes. In general, any document of value is subject to changes for fraudulent purposes. Examples include prescriptions for controlled substances like narcotic analgesics, medical records, supply chain documents like customs forms and manifests, and academic records like transcripts, letters of recommendation, and diplomas.

Drug counterfeiting has become a significant issue in the healthcare community and the pharmaceutical industry worldwide. In the absence of safety regulations imposed upon authentic equivalents, counterfeit drugs often have substandard drug quality or quantity, or harmful ingredients, exposing patients to corresponding health risks. Problems of product diversion are closely related to frank counterfeiting. Product diversion can occur at the point of manufacture, in packaging and repackaging operations, by reintroduction into the supply chain of expired or stolen product.

Additionally, many types of packages include two or more identifiers such as a bar code on a label and a separate, independent security identifier printed elsewhere on the label or embedded within a security thread or seal. One problem with conventional product identification labeling systems is that a counterfeiter may unlawfully obtain one valid label on a product and attempt to either modify that product or move the label to a different product. Currently, there is no way to quickly and easily verify that different, independent identifiers on the same product are properly correlated with one another in the way they were created when the packing was originally produced.

Accordingly, there remains a need to address these disadvantages and others not described herein.

### SUMMARY

The present disclosure describes a computing device comprising: a processor and a memory operable to: capture a first image of a first unique identifier at a first location on a candidate article; determine a first signature from the first unique identifier; retrieve a first authorization signature; capture a second image of a second unique identifier at a second location on the candidate article; determine a second signature from the second unique identifier; retrieve a second authorization signature; perform a first comparison of the first signature to the first authorization signature; perform a second comparison of the second signature to the second authorization signature; and determine, based on the first comparison and the second comparison, match information, the match information indicating whether the candidate article is a reference article.

The present disclosure further describes the computing device wherein the candidate article is a physical object chosen from the group consisting of a garment, a retail product, and a shipping package.

The present disclosure further describes the computing device wherein the first unique identifier is encrypted using the first signature.

The present disclosure further describes the computing device wherein the first unique identifier appears on a label.

The present disclosure further describes the computing device wherein the label is a tamper evident label.

The present disclosure further describes the computing device wherein the label leaves a residue after removal of the label.

The present disclosure further describes the computing device wherein one or more of the first unique identifier and the second unique identifier are serial numbers.

The present disclosure further describes the computing device wherein one or more of the first unique identifier and the second unique identifier are encoded in a pattern or code.

The present disclosure further describes the computing device wherein one or more of the first unique identifier and the second unique identifier are affixed to a label or a package.

The present disclosure further describes the computing device wherein one or more of the first unique identifier and the second unique identifier are encoded serial numbers.

The present disclosure further describes the computing device wherein one or more of the first unique identifier and the second unique identifier are not linked until affixed to an article.

The present disclosure further describes the computing device wherein a relationship between the first unique identifier and the second unique identifier is stored in data encoded in the first unique identifier and second unique identifier.

The present disclosure further describes the computing device wherein a relationship is between the first unique identifier and the second unique identifier is stored in a database.

The present disclosure further describes the computing device wherein the computing device is coupled to a bar-code reader/scanner.

The present disclosure further describes the computing device wherein computing device is coupled to the bar-code reader/scanner by NFC.

The present disclosure further describes the computing device wherein computing device is directly coupled to the bar-code reader/scanner via cable.

The present disclosure further describes the computing device wherein the computing device is coupled to the bar-code reader/scanner over a network.

The present disclosure further describes the computing device wherein the second unique identifier is encrypted and the first unique identifier contains a key or hash to decrypt the second unique identifier.

The present disclosure further describes the computing device wherein one or more of the first unique identifier, and the second unique identifier, degrades when copied.

The present disclosure further describes the computing device wherein one or more of the first unique identifier, and the second unique identifier, degrades when exposed to certain environmental conditions.

The present disclosure further describes the computing device further operable to:

detect a change to the first unique identifier by analyzing one or more of data derived from the second unique identifier and the combination of the first and second unique identifiers together.

The present disclosure further describes the computing device wherein a machine verifiable one or more of the first unique identifier and the second unique identifier are printed onto or into a security fiber or thread and wherein a mark contains variable information along its length.

The present disclosure further describes the computing device wherein the variable information forms a repeating pattern over a length greater than that used to form a security mark for a product.

The present disclosure further describes the computing device wherein the variable information forms a repeating pattern over lengths less than that used to form a security mark for a product.

The present disclosure further describes the computing device wherein the mark contains a signal for starting or stopping read of a unique identifier.

The present disclosure further describes the computing device wherein the computing device is an imaging device.

The present disclosure further describes the computing device wherein the computing device is a cell phone.

The present disclosure further describes a first device comprising: a first processor and a first memory operable to: receive, from a second device, a first signature, the first signature determined from a first image of a first unique identifier at a first location on a candidate article; receive, from a third device, a second signature, the second signature determined from a second image of a second unique identifier at a second location on the candidate article; receive a first authorization signature; perform a first comparison of the first signature to the first authorization signature; receive a second authorization signature; perform a second comparison of the second signature to the second authorization signature; and determine, based on the first comparison and the second comparison, match information, the match information indicating whether the candidate article is a reference article.

The present disclosure further describes the first device further comprising: a first network interface coupled to the first processor and the first memory operable to: couple the first device to the second device and the third device over a network, wherein the first device is a server device, the second device is a first imaging device, the third device is a second imaging device, and the first device, the second device, and the third device, are all separate devices.

The present disclosure further describes the first device further comprising: a first network interface coupled to the first processor and the first memory operable to: couple a combined said first device and said second device to the third device over a network, wherein the first device is a server device, the second device is the server device, the third device is a first imaging device, and the first device and the second are the same device, and the third device is a separate device.

The present disclosure further describes the first device further comprising: a first network interface coupled to the first processor and the first memory operable to: couple the first device to a combined said second device and said third device over a network, wherein the first device is a server device, the second device is a first imaging device, the third device is a second imaging device, and the first device is a separate device and the second device and third device are a same device.

The present disclosure further describes the first device wherein the candidate article is a physical object chosen from the group consisting of a garment, a retail product, and a shipping package.

The present disclosure further describes the first device wherein the first unique identifier is encrypted using the first signature.

The present disclosure further describes the first device wherein the first unique identifier appears on a label.

The present disclosure further describes the first device wherein the label is a tamper evident label.

The present disclosure further describes the first device wherein the label leaves a residue after removal of the label.

The present disclosure further describes the first device wherein one or more of the first unique identifier and the second unique identifier are serial numbers.

The present disclosure further describes the first device wherein one or more of the first unique identifier and the second unique identifier are encoded in a pattern or code.

The present disclosure further describes the first device wherein one or more of the first unique identifier and the second unique identifier are affixed to a label or a package.

The present disclosure further describes the first device wherein one or more of the first unique identifier and the second unique identifier are encoded serial numbers.

The present disclosure further describes the first device wherein one or more of the first unique identifier and the second unique identifier are not linked until affixed to an article.

The present disclosure further describes the first device wherein a relationship between the first unique identifier and the second unique identifier is stored in data encoded in the first unique identifier and second unique identifier.

The present disclosure further describes the first device wherein a relationship is between the first unique identifier and the second unique identifier is stored in a database.

The present disclosure further describes the first device wherein a relationship between the first unique identifier and the second unique identifier is established with one or more of the second device and the third device.

The present disclosure further describes the first device wherein one or more of the second device and the third device are coupled to a bar-code reader/scanner.

The present disclosure further describes the first device wherein the one or more of the second device and the third device are coupled to the bar-code reader/scanner by NFC.

The present disclosure further describes the first device wherein the one or more of the second device and the third device are directly coupled to the bar-code reader/scanner via cable.

The present disclosure further describes the first device wherein the one or more of the second device and the third device are coupled to the bar-code reader/scanner over a network.

The present disclosure further describes the first device wherein the second unique identifier is encrypted and the first unique identifier contains a key or hash to decrypt the second unique identifier.

The present disclosure further describes the first device wherein one or more of the first unique identifier, and the second unique identifier, degrades when copied.

The present disclosure further describes the first device wherein one or more of the first unique identifier, and the second unique identifier, degrades when exposed to certain environmental conditions.

The present disclosure further describes the first device further operable to:

detect a change to the first unique identifier by analyzing one or more of data derived from the second unique identifier and the combination of the first and second unique identifiers together.

The present disclosure further describes the first device wherein a machine verifiable one or more of the first unique identifier and the second unique identifier are printed onto or into a security fiber or thread and wherein a mark contains variable information along its length.

The present disclosure further describes the first device wherein the variable information forms a repeating pattern over a length greater than that used to form a security mark for a product.

The present disclosure further describes the first device wherein the variable information forms a repeating pattern over lengths less than that used to form a security mark for a product.

The present disclosure further describes the first device wherein the mark contains a signal for one of starting and stopping a reading of a unique identifier.

The present disclosure describes an imaging device comprising: a first network interface operable to: couple the imaging device to a server device over a network; and a first processor and a first memory coupled to the first network interface and operable to: capture an image of a unique identifier on a candidate article; determine, from the unique identifier, a signature; send, to the server device over the network, the signature; and receive, from the server device over the network, match information, wherein the match information indicates whether the candidate article matches a reference article.

The present disclosure describes a server device comprising: a first network interface operable to: couple the server device to an imaging device over a network; and a first processor and a first memory coupled to the first network interface and operable to: receive, from the imaging device, a signature, the signature determined from an image of a unique identifier on a candidate article; retrieve an authorization signature; perform a comparison of the signature to the authorization signature; determine, based on the comparison, match information, the match information indicating whether the candidate article is a reference article; and send, to the imaging device, the match information.

The present disclosure describes an imaging device comprising: a first network interface operable to: couple the imaging device to a server device over a network; and a first processor and a first memory coupled to the first network interface and operable to: capture a first image of a first unique identifier at a first location on a candidate article; determine a first signature from the first unique identifier; retrieve a first authorization signature; perform a first comparison of the first signature to the first authorization signature; receive, from a second imaging device, second comparison information, the second comparison information determined based on a second comparison of a second signature to a second authorization signature, the second signature determined based on a second image of a second unique identifier at a second location on the candidate article, the second image captured at the second imaging device; and determine, based on the first comparison and the second comparison, match information, the match information indicating whether the candidate article is a reference article.

The present disclosure describes a method comprising: generating a label containing at least a first unique identifier at a first location on the label and a second unique identifier at a second location on the label; and linking the first unique identifier and second unique identifier.

The present disclosure describes a device comprising: a processor and a memory, in determining an authentication code, operable to: determine a pattern having a length at least twice a width of the pattern; and arrange assigned variables in the pattern.

The present disclosure further describes a device wherein the assigned variables are arranged in more than one lengthwise row.

The present disclosure further describes a device wherein the assigned variables are carried by symbols.

The present disclosure further describes a device wherein each symbol carries at least 8 bits of information.

The present disclosure further describes a device wherein such code is a machine verifiable unique identifier.

The present disclosure further describes a device wherein said code is printed onto or into a security fiber or thread.

The present disclosure further describes a device wherein said code contains variable information along its length.

The present disclosure further describes a device wherein the variable information forms a repeating pattern over a length greater than that used to form a security mark for a product.

The present disclosure further describes a device wherein the variable information forms a repeating pattern over lengths less than that used to form a security mark for a product.

The present disclosure further describes a device wherein the security mark contains a signal for starting or stopping read of a unique identifier

The present disclosure further describes a device wherein the device is an imaging device.

The present disclosure further describes a device wherein the device is a server device.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a diagram of the system described in the present disclosure;

FIG. 2A is a graphical illustration of the network traffic of the system of FIG. 1 according to some aspects of the present disclosure;

FIG. 2B is a graphical illustration of the network traffic of the system of FIG. 1 according to some aspects of the present disclosure;

FIG. 3 illustrates an example input image of a security thread containing two rows of symbols for encoding information comprising a unique identifier;

FIG. 4 illustrates a black and white threshold version of FIG. 1;

FIG. 5 illustrates a first pass classification of FIG. 2 where shapes of interest are identified and color coded while noise is discarded;

FIG. 6 illustrates a second pass classification of FIG. 3 where all in-focus shapes are properly classified and stored as colors and the location and relation of those shapes are represented in established grid positions for easier comparison;

FIG. 7 is a graphical illustration of a first mark of a pair of marks containing linked information;

FIG. 8 is a graphical illustration of a second mark of a pair of marks containing linked information;

FIG. 9 is a graphical illustration of the hardware components of an imaging device according to some aspects of the present disclosure; and

FIG. 10 is a graphical illustration of the hardware components of an imaging device according to some aspects of the present disclosure.

### DETAILED DESCRIPTION

The present disclosure is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. Examples would include a smart phone, a cell phone, a pager, a personal digital assistant (PDA, e.g., with GPRS NIC), a mobile computer with a cellular radio, or the like. A typical computing device is a wireless data access-enabled device (e.g., an iPHONE® smart phone, a BLACKBERRY® smart phone, a NEXUS ONE™ smart phone, an iPAD™ device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the constrained operating environment of wireless devices on wireless networks. In a representative embodiment, the computing device is a cellular telephone or smart phone that operates over GPRS (General Packet Radio Services), which is a data technology for GSM networks. In addition to a conventional voice communication, a given computing device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a computing device, the examples may similarly be implemented on any suitable “computing device”. An imaging device 20 may be any computing device operable to take or receive image data.

The authentication code may be any appropriately configured code, including a random code of assigned variables. The code may be any of the codes illustrated in co-pending patent application Ser. No. 13/457,115 filed on Apr. 26, 2012 by the current assignee of this disclosure and application Ser. No. 14/067,945 filed on Oct. 30, 2013, the entire contents relating to the types of code, methods for imagining, methods for generating, and methods for creating a signature are incorporated by reference herein.

The method includes providing an authentication code onto a reference article associated with a person. The one or more methods provide for authentication and identification (autoID) of an article from a digital image that may come from a simple mobile application on a smart phone or any other digital imaging device, including optical scanners, remote cameras, or video feed. Any smart printer may be used to deliver autoID codes, which do not require special inks or taggants, expensive validation hardware, or proprietary printers.

The reference article associated with a person may be a garment such as a uniform. The authentication code may be provided on the uniform as a code randomly positioned on the uniform or positioned at designated places on the uniform. The code may be produced in distinct or defined limited areas or may be produced to substantially cover the uniform. The code may be sewn on, printed on, painted on, or otherwise adhered or applied on. The garment may be a multi-piece garment. In an illustrative example of a PPE, there might be provided a suit covering the persons torso, arms, and legs, shoes to cover their feet, gloves to cover their hands, and a mask or helmet to cover their face. The same authentication code could be applied to each of the suit, shoes, gloves, and mask or helmet, or alternative or differing codes could be applied to each and the server and system disclosed herein could track the differing codes.

The method may include determining a signature associated with the authentication code. This signature may be a numerical signature that is generated based on the code.

The method may include imaging a candidate article to determine an image signature of the candidate article. The imaging may be carried out by any appropriate imaging device including a mobile device having imaging capabilities, a scanner or similar camera, and the like. In one embodiment, an imaging device may be positioned proximal to a check-in or check-out location for medical equipment such as PPE. In these instances, a person may check out equipment by scanning the PPE a first time to determine the reference signature. Alternatively, the reference signature may be determined before the code is ever printed onto the article.

The reference signature and the person are thus linked with an appropriate database such as one maintained on the server. The scanning of the PPE may include scanning of each article of the PPE. In this manner, a person may have, as an example, a mask having a first authentication code and a suit having a second authentication code and the server can associate the mask and the suit together with a particular person even though the codes do not match.

The method may then include comparing the associated reference signature with the candidate image signature to determine whether the candidate article is the reference article. This comparison may be accomplished on a server or may be accomplished on the imaging device or a device coupled to the imaging device.

The imaging device may include multiple imaging devices. For example, in a surveillance setting, multiple imaging devices may be positioned within a floor plan. The imaging devices can thus track location of persons traveling from room to room or into secured or non-secured areas. The signature associated with the code may include information such as the person assigned to the article, the manufacture date of the article, permissions for the person to enter into a portion of a building or access information, and the like.

A system is thus provided. The system may include a server configured for receiving an authentication code associated with a person or a garment of a person and determining a signature associated with the authentication code and an imaging device that images a candidate article and communicates the image to the server. The server is configured to compare the associated signature with the image signature to determine whether the candidate article is the reference article. The server may communicate with the imaging device over a network, which may be a WLAN, Cellular, Blue-Tooth, or other near or far range network.

An imaging device having computer control code thereon that when executed by a processor is thus provided. The computer control code is configured to image an authentication code on a candidate article, communicate the image to a server, and receive, from the server, an indication of authenticity between the signature of the candidate article and a signature of a reference article.

In these one or more methods and embodiments disclosed herein, advantageously there is provided methodologies for line-of-sight tracking of personnel in a theater or other setting. This presents an advantage over certain radio-based or other frequency based technologies where such tracking is undesirable (such as effect on medical equipment or a way for the interrogator to be track which would thus be undesirable in a military setting) or where the signal noise from such crowded tracking would be undesirable.

The signature may be generated from processing a plurality of elements present on an article. These elements may be described using a set of source likenesses and given a numerical similarity score or a collection of numerical similarity scores. A similarity score or a set of similarity scores may be calculated by comparing a location in the article to a predefined shape or set of shapes. This comparison may be done by using an image representation of the location on the article and performing a correlation operation between the image representation and an image representation of the shape or set of shapes. This operation may produce a similarity score or set of similarity scores from the result of the correlation operation. The signature may contain the similarity score or the collection of scores. The collection of similarity scores can be stored and they can also be compared to determine similarity between two sets of such scored. These elements may be represented as a digital image and processed by a software code which calculates the aforementioned similarity scores. The software code may also compare two sets of scores to determine similarity between scores in the set or the sets as a whole.

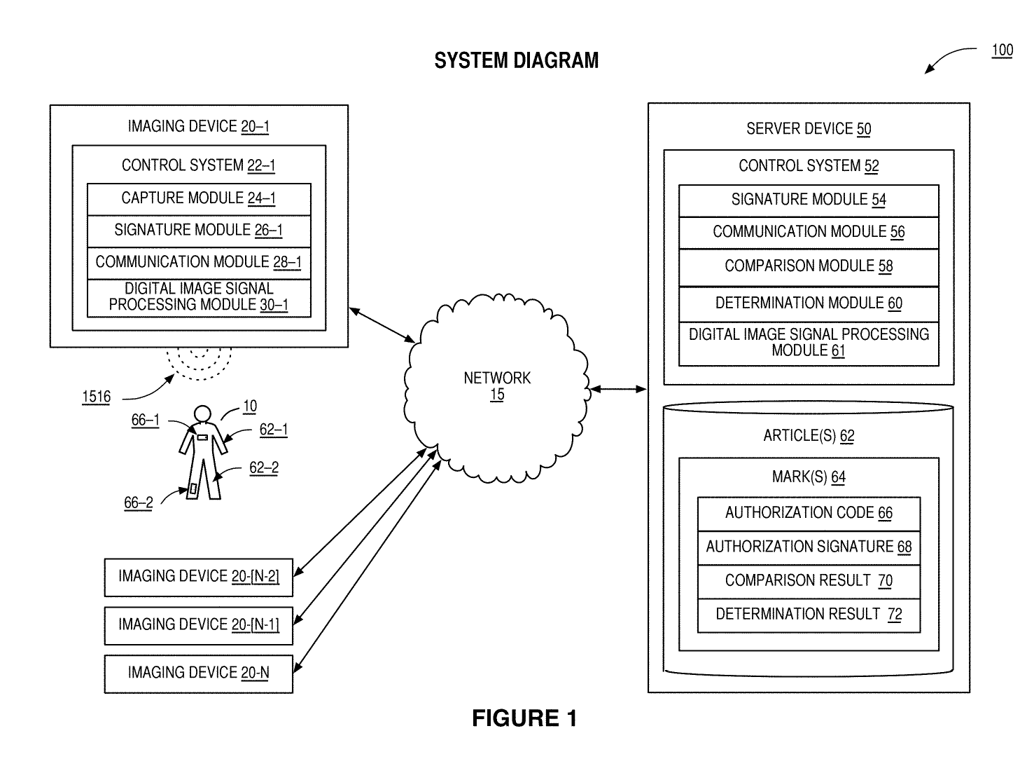

FIG. 1 illustrates a diagram of the system described in the present disclosure. The system is comprised of one or more imaging devices 20[1-N] and server device 50 coupled through a network 15. The imaging device 20 is comprised of control system 22, capture module 24, signature module 26, and a communication module 28, and a digital image signal processing module 30. The capture module 24 operates to capture images of authorization codes 66 affixed to articles 62. In some instance the article 62 may be associated with a physical object. In this particular example, the article 62 is worn by a person 10. The signature module 26 operates to determine a signature from the authorization code 5. The communication module 28 operates to send the signature to the server device 50 through the network 15. The digital image signal processing module 30 operates to perform various signal processing operations, e.g. filtering, pattern matching, correlations, etc.

The server device 50 is comprised of control system 52, signature module 24, communication module 56, comparison module 58, and a determination module 60. A data store stores one or more articles 62, each containing one or more marks 64, each mark containing an authorization code 66, authorization signature 68, comparison result 70, and a determination result 72.

The signature module 54 operates to determine a signature from the authorization code 66. The communication module 56 operates to receive the signature from the imaging device 20 through the network 15. The comparison module 58 operates to make comparisons between authorization code 66 and signature 68 to determine match information. The determination module 60 operates to determine if the authorization code 66 and signature 68 match based on the match information. The digital image signal processing module 61 operates to perform various signal processing operations, e.g. filtering, pattern matching, correlations, etc.

The server device 50 operates to store one or more articles 62, each article 62 comprising one or more marks 64, mark comprising an authorization code 66, an authorization signature 68, a comparison result 70, and a determination result 72.

In some embodiments, the elements of the server device and the imaging device 20 are incorporated into the single unitary device, and the single unitary device is operable to perform all of the operations attributed to either. In some embodiments, the imaging device is a computing device. In some embodiments, the computing device is coupled to a bar code scanner. In some embodiments, the computing device is a cell phone.

As used herein, an article is a physical object on which a label may be applied. Examples of articles would include garments, shipping boxes, vehicles, personal property, electronics, etc.

As used herein, a reference article is an article whose identity is known. For example, a person whose identity is known.

As used herein, a candidate article is an article whose identity is to be determined by examination of a mark applied to the article. For example, a person whose identity is not known.

As used herein, a label comprises machine detectable information affixed to an article. A mark may be applied to an article through a number of different means including printing on the article or affixing a label to an article. A mark may be visible to the human eye, or invisible but machine readable, as in the case of magnetic ink.

As used herein, a mark comprises a label that is embedded with an authorization code. Authorization codes are selected to be unique, and unique identify the article within the disclosed system. A mark may be applied to an article through a number of different means including printing on the article or affixing a label to an article. A mark may be visible to the human eye, or invisible but machine readable, as in the case of magnetic ink.

As used herein, an authentication code may be any appropriately configured code, including a random code of assigned variables. The code may be any of the codes illustrated in co-pending patent application Ser. No. 13/457,115 filed on Apr. 26, 2012 by the current assignee of this disclosure and application Ser. No. 14/067,945 filed on Oct. 30, 2013, the entire contents relating to the types of code, methods for imaging, methods for generating, and methods for creating a signature are incorporated by reference herein.

As used herein, a signature may be a numerical signature determined from the authorization code. In some embodiments, the signature is a numerical signature.

As used herein, a unique identifier is any identifier that is unique within the disclosed system. An example of a unique identifier would be an authorization code.

As used herein, a barcode is an optical, machine-readable, representation of data; the data usually describes something about the object that carries the barcode. Originally barcodes systematically represented data by varying the widths and spacing of parallel lines, and may be referred to as linear or one-dimensional (1D). Later two-dimensional (2D) codes were developed, using rectangles, dots, hexagons and other geometric patterns in two dimensions, usually called barcodes although they do not use bars as such. Characteristic of barcode technologies is that each position carries just two bits of information, i.e., a location is black (1) or white (0).

As used herein, a security thread is physical fiber capable of being imprinted with a machine-readable mark

As used herein, a tamper evident seal is seals where it is possible to detect if the seal has been opened or tampered with. As used herein the tamper evident seal may contain an embedded security thread.

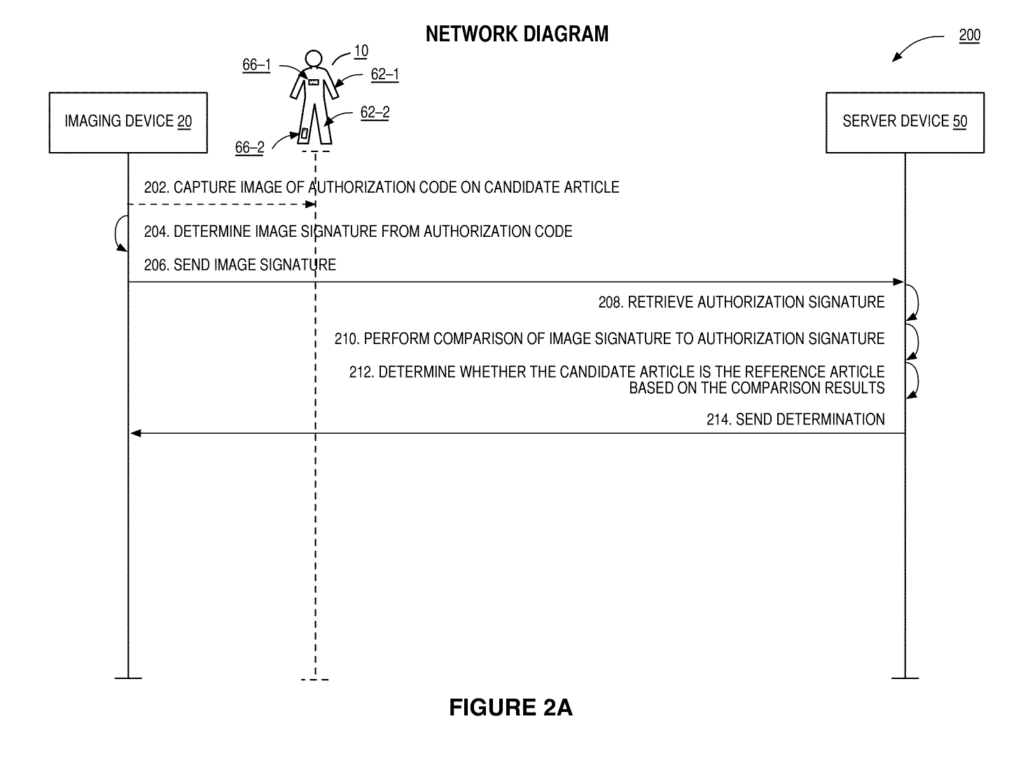

FIG. 2A is a graphical illustration of the network traffic of the system of FIG. 1 according to some aspects of the present disclosure. The imaging device 20 operates 202 to take an image of an authorization code 66 on a candidate article 62. The imaging device 20 determines 204 an image signature from the authorization code 66, and sends 206 the image signature to the server device 50. The server device 50 retrieves 208 the authorization signature 68, and performs 210 a comparison of the image signature to the authorization signature 68. The server device 50 determines 212 whether the candidate article is the reference article based on the comparison results 70. The server device 50 sends 214 the determination result 72 to the imaging device 20.

FIG. 2B is a graphical illustration of the network traffic of the system of FIG. 1 according to some aspects of the present disclosure. The first imaging device 20-1 operates 252-1 to take a first image of a first authorization code 66 on a first candidate article 62. The first imaging device 20-1 determines 254-1 a first image signature from the first authorization code 66, and sends 256-1 the first image signature to the server device 50. The second imaging device 20-N operates 252-N to take a second image of a second authorization code 66 on a second candidate article 62. The second imaging device 20-N determines 254-N a second image signature from the second authorization code 66, and sends 256-N the second image signature to the server device 50.

The server device 50 retrieves 258 the first authorization signature 68, and performs 260 a first comparison of the first image signature to the first authorization signature 68. The server device 50 retrieves 262 the second authorization signature 68, and performs 264 a second comparison of the second image signature to the second authorization signature 68. The server device 50 determines 266 whether the candidate article is the reference article based on the first comparison results and the second comparison results 70. The server device 50 may send 268-1 268-N the determination result 72 to the first imaging device 20 and the second imaging device 20.

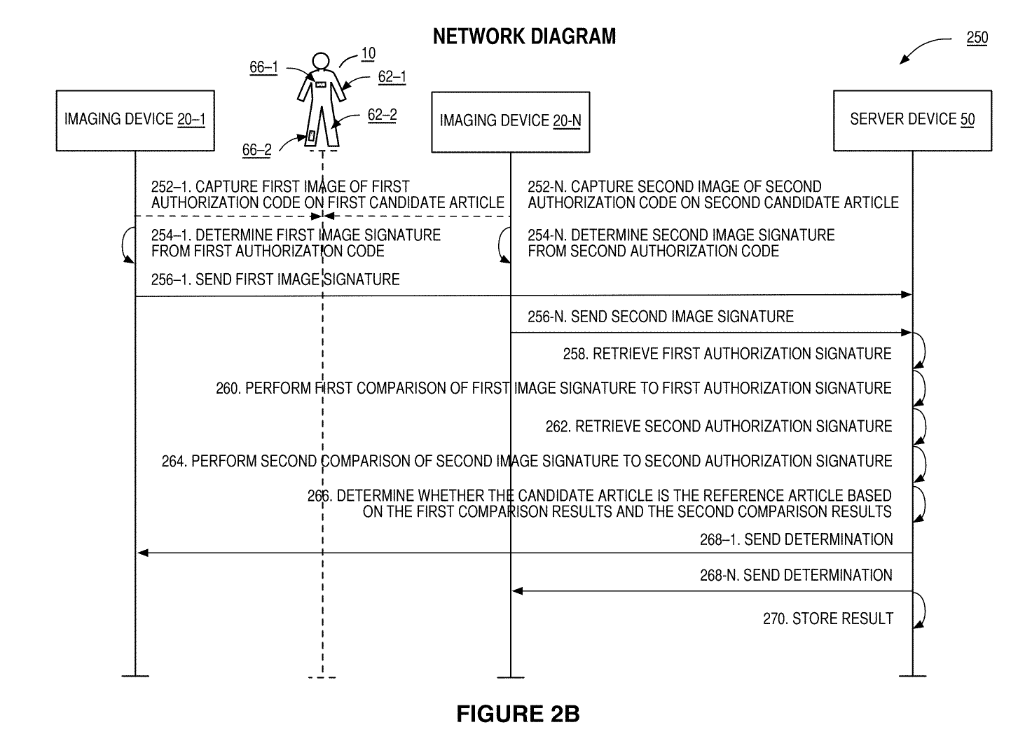

FIG. 3 illustrates an example input image of a security thread containing two rows of symbols for encoding information comprising a unique identifier. In some embodiments, the image is captured by the imaging device 20.

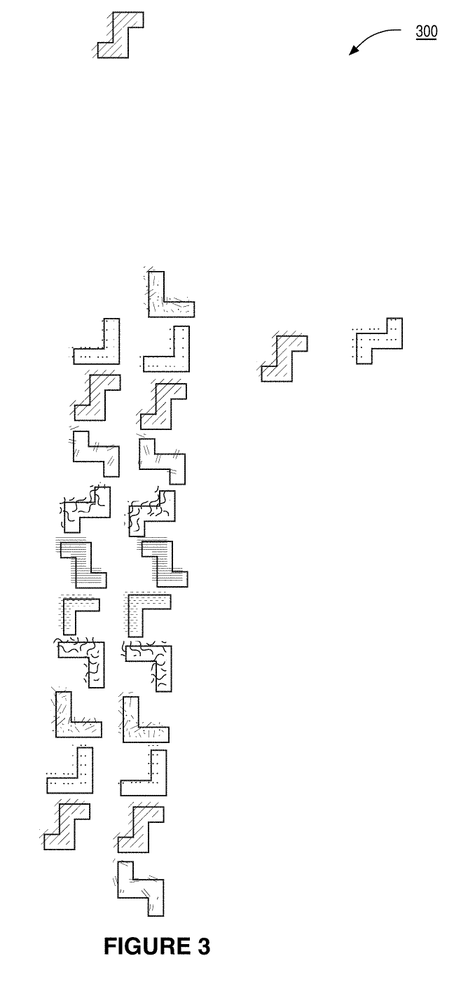

FIG. 4 illustrates a black and white threshold version of the image captured in FIG. 3. In some embodiments, the white threshold version of the image is computed by the digital image signal processing module 30-1. In some embodiments, the white threshold version of the image is computed by the digital image signal processing module 61.

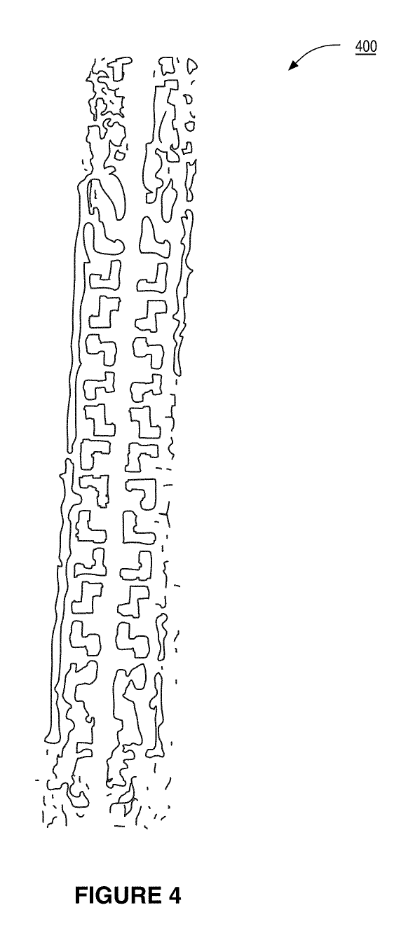

FIG. 5 illustrates a first pass classification of FIG. 4 where shapes of interest are identified and color coded while noise is discarded. In FIG. 5, like colors are represented by like patterns. In some embodiments, the first pass classification of is computed by the digital image signal processing module 30-1. In some embodiments, the first pass classification of the image is computed by the digital image signal processing module 61.

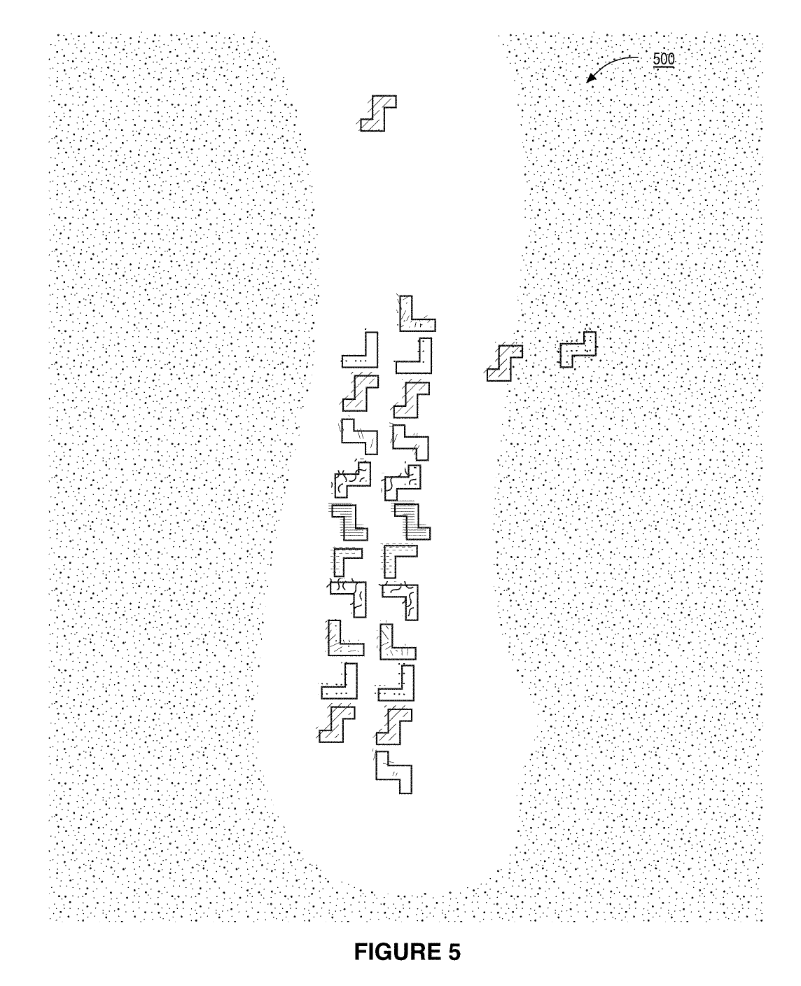

FIG. 6 illustrates a second pass classification of FIG. 5 where all in-focus shapes are properly classified and stored as colors and the location and relation of those shapes are represented in established grid positions for easier comparison. In FIG. 6, like colors are represented by like patterns. In some embodiments, the second pass classification of is computed by the digital image signal processing module 30-1. In some embodiments, the second pass classification of the image is computed by the digital image signal processing module 61.

Packaging for products may contain any number of security features designed to detect and deter a number of unintended or unwanted supply chain activities (like introduction of counterfeits or gray market distribution) or simply to determine the state of use of a product. While barcodes and holograms work to provide authenticity and security, other marks, such as TraxSecur, aim to provide fraud detection. These all work together to provide the manufacturer and consumer a secure supply chain that protects everyone involved.

Only recently are all of these technologies taking advantage of the interlinked data systems that comprise the internet. Part of this drive comes from the Internet of Things [IoT] idea that links all objects to this massive network of information and processing. However impressive digital links can become, there are still, by necessity, interactions with physical goods. Linking all of the myriad products and packages consumers use every day is part of this goal, and helps create a secure interconnected digital environment.

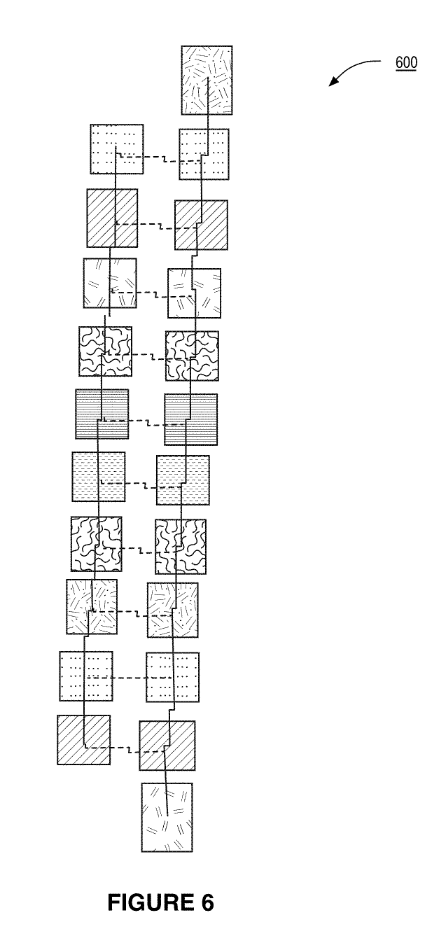

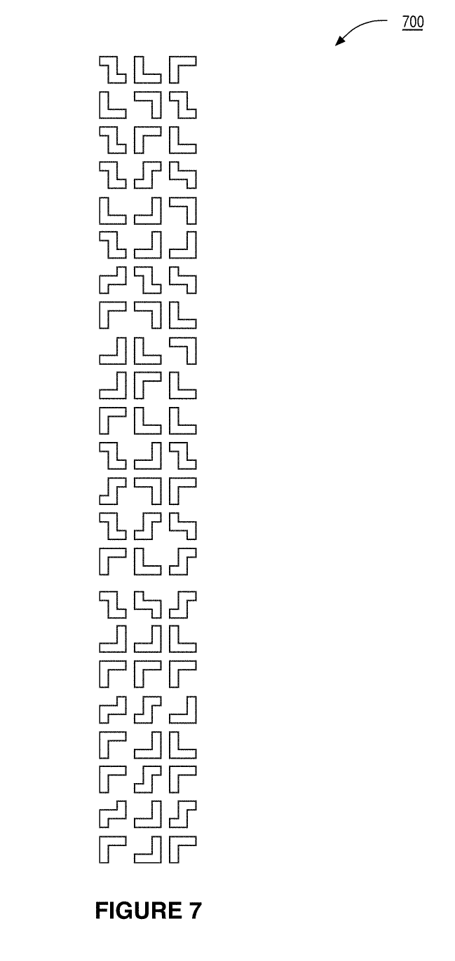

Referring now to FIG. 7, the mark 700 represents a CertiRx TraxSecur mark that contains information linked to the information in the DataMatrix Barcode in mark 800 of FIG. 8. The two marks contain linked information. Mark 700 can also be a DataMatrix or other data carrier, as well as Mark 800 can be a mark that contains data of any other sort.

In one example, barcode may be used, according to the Drug Quality and Safety Act (DQSA) requirements for packaging, to carry a copy of the human readable information that contains the track and trace information required to be present on the packaging. This redundancy of information helps secure the package from tampering; however, the present invention extends the idea of linked information systems further.

In another example, two or more barcodes contain identical information. For a person to know if the package was genuine, all marks would be read and the product would pass if and only if all information matched.

In another example, the barcodes may each contain part of a message. The product would be determined to be genuine if all parts of the message are present and complete. In practice, this message would be unpredictable so that the missing part could not easily be guessed.

In some cases, it may not be practical for all pieces to be read and present. The amount of information can be reduced by using state of the art encryption and/or hashing schemes. This provides a way to verify the information by comparing it to a subset of other marks. In one case, two marks would contain hash values for the contents of the other. By scanning both, you verify both are valid and contain the information the other mark expects.

These methods can be applied to marks other than barcodes. TraxSecur codes, security fibers, holograms, propriety barcodes, hidden images, “Invisible ink” marks, and a number of other security methods that allow manufacturers to encode information, either by reference or incorporation, into a product, package, or other article.

A further example of how this method works when used with printed security fibers shows the versatility of this technology for authentication. With a custom printed security fiber from INTEGRITY SYSTEMS that contains information, information was embedded into the fiber such that the fiber contains a “key” for unlocking barcode information elsewhere on the article.

TraxSecur is shown in the referenced images as the data carrier for such a key. This fiber can also be used by printing a fully random sequence of data using TraxSecur to provide unique strings when cut and incorporated into articles. The TraxSecur code is sufficiently complex to yield a unique identifier for any given length of the fiber. Unique identifiers can also be encoded by incorporating a specified “start” and “stop” sequence. Repeating identifiers can also be delimited with such start/stop sequences.

This fiber can also be incorporated into tamper evident seals where it will be destroyed on opening or attempting to open a product. This would break the automated verification between the fiber and other marks on the package or item.

Using destructible carriers for delivering marks, a system can be configured to read a destroyed mark as destroyed. This allows the information to be validated and has the ability to alert users to changes in the state of the product.

Destructible marks or carriers include die-cut labels, special adhesives, special inks, special paper, and other environmentally sensitive components.

These marks can also be configured to degrade predictably under specific environmental conditions. A TraxSecur mark can have a configuration that alters portions of the secured area or the data carrying area itself to return a different value.

This can be done using moisture sensitive inks, light sensitive inks, tilt or tip sensitive labels, pH indicators, and temperature sensitive inks, in addition to a number of other environmentally sensitive components.

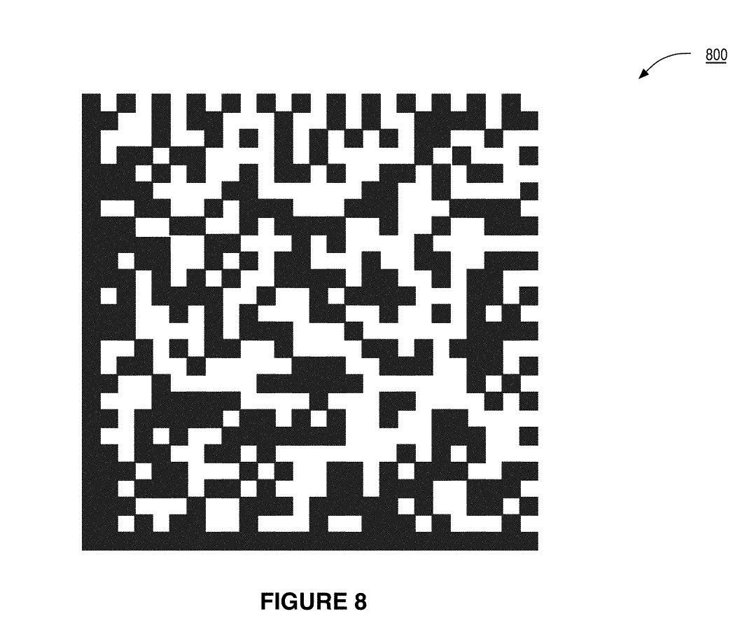

FIG. 9 is a block diagram of an imaging device according to one embodiment of the present disclosure. As illustrated, the imaging device 20 includes a controller 904 connected to memory 906, one or more communications interfaces 908, one or more user interface components 910, one or more storage components 912, and a location component 914 by a bus 902 or similar mechanism. The controller 904 is a microprocessor, digital ASIC, FPGA, or the like. In general, the imaging device 20 includes a control system 22 having associated memory 906. In this embodiment, the controller 904 is a microprocessor, and the capture module 24, signature module 26, communication module 28, and digital image signal processing module 30 operates to perform various signal processing operations, e.g. filtering, pattern matching, correlations, etc. are implemented in software and stored in the memory 906 for execution by the controller 904. However, the present disclosure is not limited thereto. The aforementioned functions and module may be implemented in software, hardware, or a combination thereof. The imaging device 20 also includes a communication interface 908 enabling the imaging device 20 to connect to the network 15. The one or more user interface components 910 include, for example, a touchscreen, a display, one or more user input components (e.g., a keypad), a speaker, or the like, or any combination thereof. The storage component(s) 912 is a non-volatile memory. In this embodiment, the location component 914 is a hardware component, such as a GPS receiver. However, the present invention is not limited thereto.

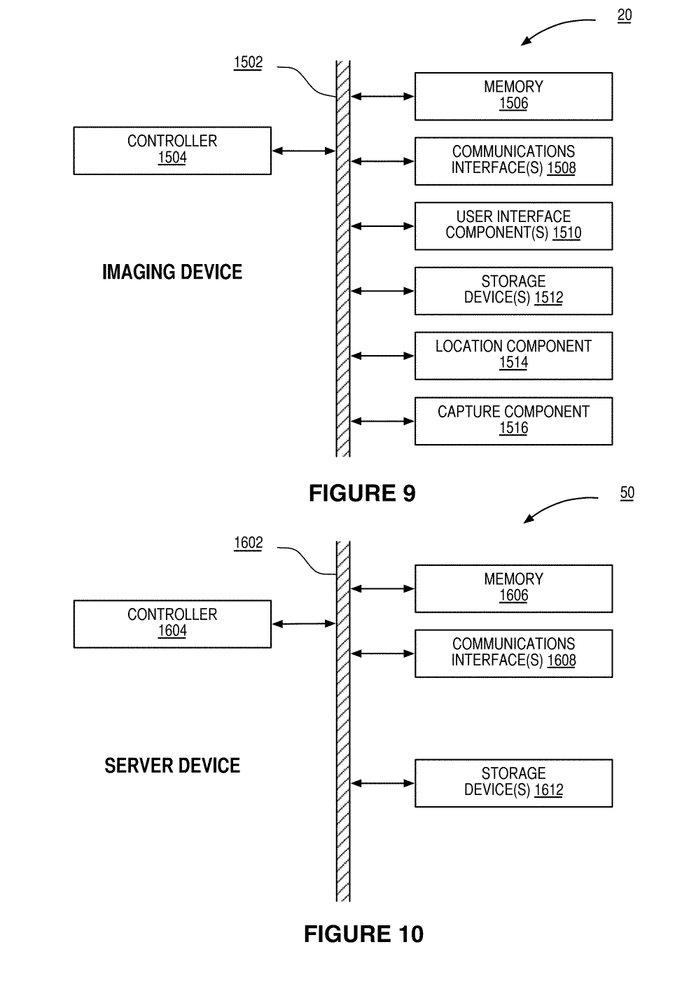

FIG. 10 is a block diagram of a server device 50 according to one embodiment of the present disclosure. As illustrated, the server device 50 includes a controller 1004 connected to memory 1006, one or more communications interfaces 1008, one or more user interface components 1010, one or more storage components 1012 by a bus 1002 or similar mechanism. The controller 1004 is a microprocessor, digital ASIC, FPGA, or the like. In general, the server device 50 includes a control system 52 having associated memory 1006. In this embodiment, the controller 1004 is a microprocessor, and the signature module 54, communication module 56, comparison module 58, determination module 60, and digital image signal processing module 61 are implemented in software and stored in the memory 1006 for execution by the controller 1004. However, the present disclosure is not limited thereto. The aforementioned modules may be implemented in software, hardware, or a combination thereof. The server device 50 also includes a communication interface 1008 enabling the reference server device 50 to connect to the network 15. The one or more user interface components 1010 include, for example, a touchscreen, a display, one or more user input components (e.g., a keypad), a speaker, or the like, or any combination thereof. The storage component(s) 1012 is a non-volatile memory. In some embodiments, the storage device(s) 1612 include one or more databases operable to store one or more articles 62, each containing one or more marks 64, each mark containing an authorization code 66, authorization signature 68, comparison result 70, and a determination result 72.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Throughout this specification, like reference numbers signify the same elements throughout the description of the figures.

When elements are referred to as being “connected” or “coupled”, the elements can be directly connected or coupled together or one or more intervening elements may also be present. In contrast, when elements are referred to as being “directly connected” or “directly coupled,” there are no intervening elements present.

Recitation of ranges of values herein are merely intended to serve as a shorthand method of referring individually to each separate value falling within the range, unless otherwise indicated herein, and each separate value is incorporated into the specification as if it were individually recited herein. Therefore, any given numerical range shall include whole and fractions of numbers within the range. For example, the range “1 to 10” shall be interpreted to specifically include whole numbers between 1 and 10 (e.g., 1, 2, 3, . . . 9) and non-whole numbers (e.g., 1.1, 1.2, . . . 1.9).

Although process (or method) steps may be described or claimed in a particular sequential order, such processes may be configured to work in different orders. In other words, any sequence or order of steps that may be explicitly described or claimed does not necessarily indicate a requirement that the steps be performed in that order unless specifically indicated. Further, some steps may be performed simultaneously despite being described or implied as occurring non-simultaneously (e.g., because one step is described after the other step) unless specifically indicated. Where a process is described in an embodiment the process may operate without any user intervention.

Those skilled in the art will recognize improvements and modifications to the embodiments of the present disclosure. All such improvements and modifications are considered within the scope of the concepts disclosed herein and the claims that follow.

What is claimed is:

1. A computing device comprising:
a processor and a memory operable to:
capture a first image of a first unique identifier at a first location on a candidate article;
determine a first signature from the first unique identifier;
retrieve a first authorization signature;
capture a second image of a second unique identifier at a second location on the candidate article;
determine a second signature from the second unique identifier;
retrieve a second authorization signature;
perform a first comparison of the first signature to the first authorization signature;
perform a second comparison of the second signature to the second authorization signature; and
determine, based on the first comparison and the second comparison, match information, the match information indicating whether the candidate article is a reference article.

2. The computing device of claim 1 wherein the candidate article is a physical object chosen from the group consisting of a document, garment, a retail product, and a shipping package.

3. The computing device of claim 1 wherein the first image and second image are captured substantially concurrently.

4. The computing device of claim 1 wherein one or more of the first unique identifier and the second unique identifier are serial numbers encoded in a pattern or code.

5. The computing device of claim 1 wherein one or more of the first unique identifier and the second unique identifier are not linked until affixed to an article.

6. The computing device of claim 1 wherein a relationship between the first unique identifier and the second unique identifier is stored in data encoded in the first unique identifier and second unique identifier.

7. The computing device of claim 1 wherein a relationship is between the first unique identifier and the second unique identifier is stored in a database.

8. The computing device of claim 1 wherein the second unique identifier is encrypted and the first unique identifier contains a key or hash to decrypt the second unique identifier.

9. The computing device of claim 1 wherein one or more of the first unique identifier, and the second unique identifier, degrades when copied.

10. The computing device of claim 1 wherein one or more of the first unique identifier, and the second unique identifier, degrades when exposed to certain environmental conditions.

11. The computing device of claim 1 further operable to:
detect a change to the first unique identifier by analyzing one or more of data derived from the second unique identifier and the combination of the first and second unique identifiers together.

12. The computing device of claim 1 wherein the computing device is an imaging device.

13. The computing device of claim 1 further comprising:
a first network interface operable to:
couple the first device to a second device and a third device over a network, wherein
the computing device is a server device,
the second device is a first imaging device,
the third device is a second imaging device.

14. The computing device of claim 13, wherein said device is an imaging device.

15. The computing device of claim 13, wherein said device is a server device.

16. A method comprising:
capturing a first image of a first unique identifier at a first location on a candidate article;
determining a first signature from the first unique identifier;
retrieving a first authorization signature;
capturing a second image of a second unique identifier at a second location on the candidate article;
determining a second signature from the second unique identifier;
retrieving a second authorization signature;
performing a first comparison of the first signature to the first authorization signature;
performing a second comparison of the second signature to the second authorization signature; and
determining, based on the first comparison and the second comparison, match information, the match information indicating whether the candidate article is a reference article.

17. The method of claim 16 wherein the candidate article is a physical object chosen from the group consisting of a document, garment, a retail product, and a shipping package.

18. The method of claim 16 wherein the first image and second image are captured substantially concurrently.

19. The method of claim 16 wherein one or more of the first unique identifier and the second unique identifier are serial numbers encoded in a pattern or code.

20. The method of claim 16 wherein a relationship between the first unique identifier and the second unique identifier is stored in data encoded in the first unique identifier and second unique identifier.
